(19) United States
(12) Patent Application Publication
(10) Pub. No.: US 2012/0280813 A1
(43) Pub. Date: Nov. 8, 2012

(54) SERVICE PROVISIONING IN A WIRELESS COMMUNICATIONS NETWORK

(76) Inventors: Inderpreet Singh Ahluwalia, Austin, TX (US); Weidong Hu, Austin, TX (US)

(21) Appl. No.: 13/101,245

(22) Filed: May 5, 2011

(51) Int. Cl. G08B 21/00

(52) U.S. Cl. 340/540

(57) ABSTRACT

An apparatus includes a memory containing a subscriber entitlement profile for a subscriber to a wireless communications network. The apparatus includes a controller configured to provide an indication of whether the subscriber is entitled to a service based on the subscriber entitlement profile. The memory and controller may be included in an integrated circuit card. The service may be unassociated with a rate plan associated with the subscriber. The apparatus may include a service entitlement facility configured to access a service of the communications network based on a user request for the service and the indication. The service entitlement facility may be further configured to determine whether or not a subscriber is entitled to the service of the wireless communications network based on the subscriber entitlement profile stored in the memory and further configured to access the service if the subscriber is entitled to the service.

### BACKGROUND

1. Field of the Invention

This application is related to wireless communications networks and more specifically, to provisioning services of a wireless communications network to a mobile communications device.

2. Description of the Related Art

In general, a subscriber of wireless communications services (i.e., a subscriber) establishes a contract (i.e., a rate plan) with a mobile communications provider for a set of services. However, the wireless communications provider may offer new and/or additional services that may be provisioned to a mobile communications device associated with a subscriber in addition to the set of services that is covered by the rate plan. For example, a subscriber to wireless communications services may want to use a service that tethers a mobile communications device to a personal computer, allowing the mobile communications device to serve as a modem for the personal computer or the subscriber may want to use their mobile communications device as a WiFi access point (i.e., hotspot). Accordingly, techniques are desired to provision a mobile communications device for services that are not included in the associated subscriber rate plan.

### SUMMARY

In at least one embodiment of the invention, a method for provisioning a mobile communications device for a service includes transmitting a first indicator indicating a change to a service entitlement profile stored on the mobile communications device. The first indicator is transmitted by a wireless communications network to the mobile communications device. In at least one embodiment, the method includes transmitting a second indicator indicating entitlement to a service and an associated service access point name. The second indicator is transmitted by the wireless communications network to the mobile communications device. In at least one embodiment of the method, the first indicator is transmitted in response to a communication between a subscriber associated with the mobile communications device and customer care associated with the wireless communications network.

In at least one embodiment of the invention, an apparatus includes a memory containing a subscriber entitlement profile for a subscriber to a wireless communications network. The apparatus includes a controller configured to provide an indication of whether the subscriber is entitled to a service based on the subscriber entitlement profile. In at least one embodiment of the apparatus, the memory and controller are included in an integrated circuit card. In at least one embodiment of the apparatus, the service is not associated with a rate plan associated with the subscriber. In at least one embodiment, the apparatus includes a service entitlement facility configured to access a service of the communications network based on a user request for the service and the indication. In at least one embodiment, the service entitlement facility is further configured to determine whether or not a subscriber is entitled to the service of the wireless communications network based on the subscriber entitlement profile stored in the memory and further configured to access the service if the subscriber is entitled to the service. In at least one embodiment, the service entitlement facility is further configured to update the subscriber entitlement profile in response to an over-the-air message including an indicator indicating a change to the subscriber entitlement profile.

In at least one embodiment of the invention, a method includes accessing a service access point of a wireless communications network in response to a request for the service and according to a subscriber entitlement profile stored in a mobile communications device. In at least one embodiment of the method, the service entitlement profile is stored in an integrated circuit card of the mobile communications device. In at least one embodiment of the method, the service is not associated with a rate plan associated with the mobile communications device. In at least one embodiment of the method, the accessing includes establishing a connection between the mobile communications device and the communications network in response to the request for the service and in response to a service entitlement indicator of the subscriber entitlement profile indicating that a subscriber associated with the mobile communications device is entitled to the service.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a simplified diagram of an exemplary wireless communications network.

FIG. 2 illustrates exemplary information and control flows for determining whether a subscriber associated with a mobile communications device is entitled to a service of a wireless communications network.

FIG. 3 illustrates exemplary information and control flows for provisioning a mobile communications device with services of a wireless communications network for which a subscriber associated with the mobile communications device is entitled.

FIG. 4 illustrates a mobile communications device consistent with at least one embodiment of the invention.

FIGS. 5A and 5B illustrate data structures for a subscriber entitlement profile consistent with at least one embodiment of the invention.

FIG. 6 illustrates exemplary information and control flows for providing a service to a mobile communications device associated with a subscriber with a service of a wireless communications system that is not part of the subscriber's rate plan consistent with at least one embodiment of the invention.

FIG. 7 illustrates exemplary information and control flows for provisioning a mobile communications device associated with a subscriber for a service of a wireless communications system that is not part of the subscriber's rate plan for which the subscriber is entitled consistent with at least one embodiment of the invention.

The use of the same reference symbols in different drawings indicates similar or identical items.

### DETAILED DESCRIPTION

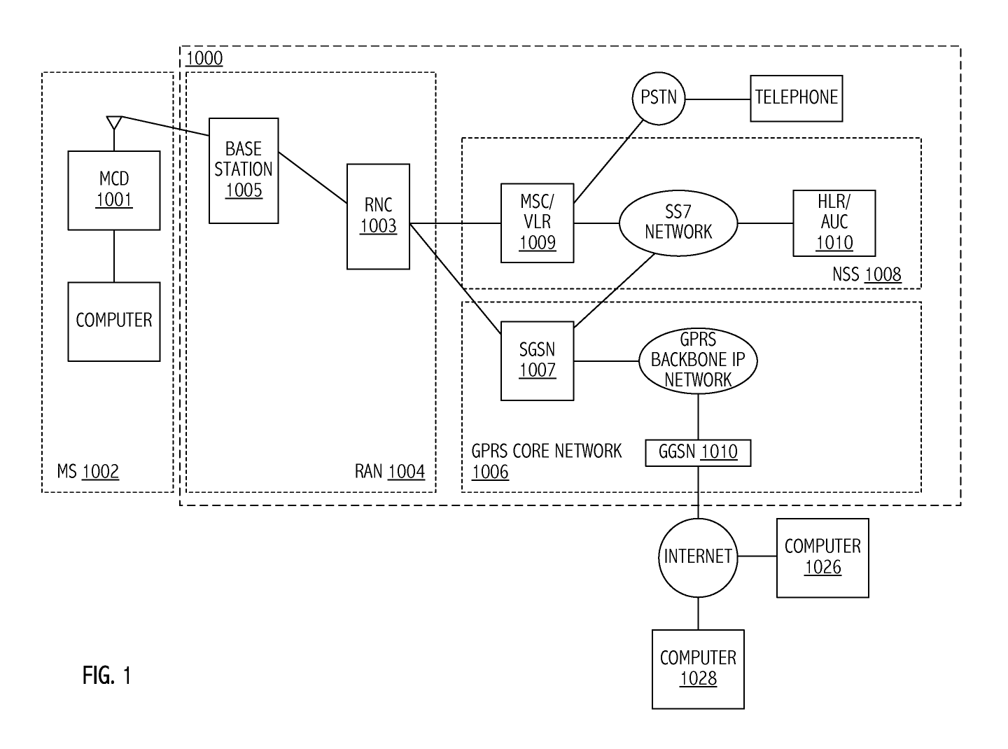

Referring to FIG. 1, an exemplary wireless communications network (e.g., wireless communications network 1000) is consistent with second generation wireless telephone technology (2G) and/or Wideband Code Division Multiple Access (W-CDMA) based third generation mobile wireless telephone technology (3G) mobile telephony standards. In at least one embodiment of wireless communications network 1000, a mobile station (e.g., mobile station 1002) communicates with a Radio Access Network (e.g., RAN 1004), which includes base station (e.g., Node B or Base Station 1005) and a Radio Network Controller (e.g., RNC 1003). In at least one embodiment of wireless communications network 1000, RAN 1004 handles the traffic and signaling between a mobile communications device (e.g., mobile communications device 1001) and a network switching subsystem (e.g., NSS 1008). In at least one embodiment, mobile communications device 1001 is a smart phone or other mobile communications device configured to send and receive digital data over a wireless communications network. Radio Access Network 1004 transcodes speech channels, allocates radio channels to mobile communications device 1001, facilitates transmission and reception over the air interface, and performs other tasks related to the radio network. In at least one embodiment, RAN 1004 performs processing tasks for packet data.

In at least one embodiment of wireless communications network 1000, NSS 1008 handles call switching and mobility management functions for mobile communications devices roaming on a network of base stations and facilitates communications between mobile communications devices and the Public Switched Telephone Network (PSTN). In at least one embodiment of NSS 1008, the mobile switching center (e.g., MSC 1009) sets up and releases end-to-end connections, facilitates handover during a call, and handles charging and pre-paid account monitoring. When MSC 1009 is the MSC associated with a current location of a mobile communications device, the Visitor Location Register (VLR) will contain data for the subscriber associated with the mobile communications device. The Home Location Register and Authentication Center (e.g., HLR/AUC 1010) includes a central database that contains information associated with each subscriber authorized to use wireless communications network 1000 and authenticates each mobile communications device associated with those subscribers that attempts to connect to core network (e.g., General Packet Radio Service (GPRS) core network 1006), typically when the mobile communications device powers on or otherwise attempts to register with wireless communications network 1000.

In at least one embodiment of wireless communications network 1000, GPRS core network 1006 provides Internet Protocol (IP) packet communications services. Although shown separately in FIG. 1, in some embodiments of a network, GPRS core network 1006 is integrated with NSS 1008. In general, GPRS core network 1006 provides mobility management, session management, and transport for IP packet services. In at least one embodiment, GPRS core network 1006 provides support for other network functions (e.g., billing and customer care). In at least one embodiment, GPRS core network 1006 implements a GPRS tunneling protocol that allows end users of wireless communications network 1000 to move from place to place while maintaining a connection to the internet as if from one location at a Gateway GPRS Support Node (e.g., GGSN 1010). The GPRS tunneling protocol accomplishes this by communicating the subscriber's data from the subscriber's current Serving GPRS Support Node (e.g., SGSN 1007) to the GGSN that is handling the associated session.

If a user of mobile communications device 1001 attempts to use a service that is not part of the rate plan for the subscriber associated with mobile communications device 1001, (e.g., tethering or other service not part of the rate plan), an exemplary technique provisions mobile communications device 1001 for the service in addition to the set of services that is covered by the rate plan. The technique uses an entitlement Access Point (e.g., computer 1026) having an Access Point Name (APN) that the mobile communications device consults to determine whether the subscriber is entitled to use that service. In general, an APN allows a mobile communications device to access a resource (e.g., access point) coupled to the internet (e.g., computer 1026 or computer 1028) using the wireless communications network. An exemplary APN includes a network identifier and an operator identifier. Wireless communications network 1000 uses the APN to determine what type of network connection should be created, e.g., what IP addresses should be assigned to the wireless device, what security methods should be used, and/or how should it be connected to a private customer network.

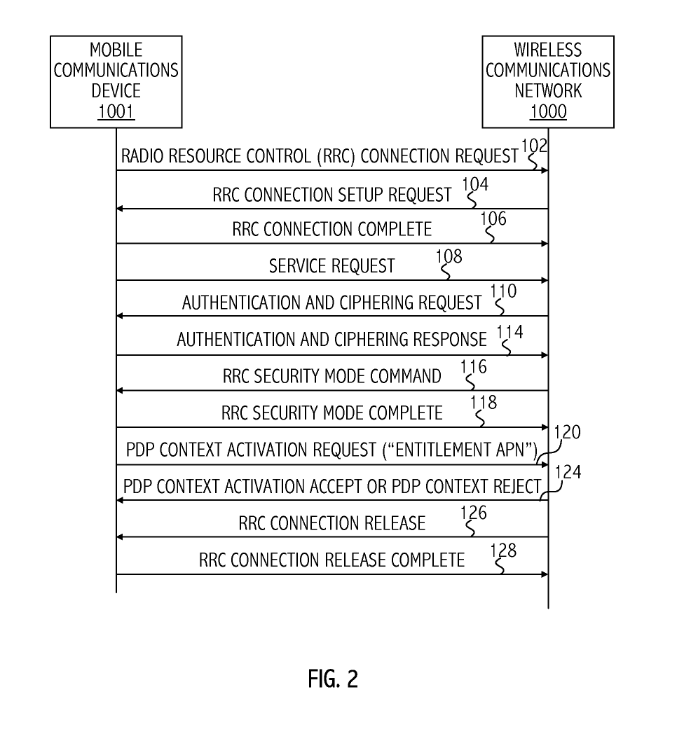

Referring to FIGS. 1 and 2, in response to an attempt by a user to access the service using mobile communications device 1001, mobile communications device 1001 consults the access point using the entitlement APN to determine whether mobile communications device 1001 is entitled to use that service. The mobile communications device is configured to establish a Packet Data Protocol (PDP) context to the entitlement APN (e.g., messages 102-120). That is, the mobile communications device is configured to allocate a PDP context data structure in SGSN 1008 that the subscriber is currently visiting and in GGSN 1010. That data structure includes the subscriber's session information when the subscriber has an active session. In at least one embodiment, the data structure includes the subscriber's Internet Protocol (IP) address, the subscriber's International Mobile Subscriber Identity (IMSI), a subscriber's Tunnel Endpoint ID (TEID) at the GGSN, and the subscriber's TEID at the SGSN. A subscriber's TEID is a number allocated by the GSN that identifies tunneled data related to a particular PDP context.

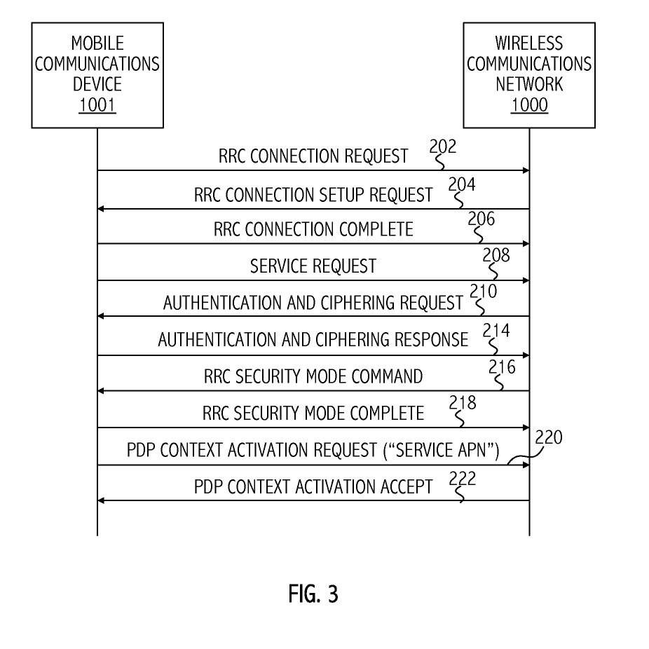

In at least one embodiment of wireless communications network 1000, successful establishment of the PDP context on the access point associated with the entitlement APN (see, e.g., a PDP Context Activation Accept of message 124) indicates to mobile communications device 1001 that the subscriber is entitled to that service (e.g., a feature code is provisioned to that subscriber account). If the subscriber is entitled to the service, the mobile communications device deactivates the entitlement PDP context (e.g., messages 124-128 of FIG. 2) and re-establishes a PDP context to an access point that will provide the service (e.g., messages 202-220 of FIG. 3).

Referring back to FIG. 2, an unsuccessful attempt to establish the PDP context on the access point associated with entitlement APN (see, e.g., a PDP Context Reject of message 124) indicates to mobile communications device 1001 that the subscriber is not entitled to that service and no further signaling occurs. Accordingly, mobile communications device 1001 provides to the user an indication of no entitlement to the service. In at least one embodiment, mobile communications device 1001 displays a message indicating that the subscriber is not entitled to the service. In at least one embodiment, mobile communications device 1001 indicates that the user should contact customer care to provision the service entitlement. Note that only network layer (i.e., layer 3) messages between mobile communications device 1001 and wireless communications network 1000 are illustrated in FIGS. 2 and 3. However, additional signaling (e.g., signaling between elements within wireless communications network 1000) occurs. Thus, this technique results in substantial signaling and use of network resources each time a mobile communications device attempts to use a service that is not part of the subscriber's rate plan. In addition, any time the entitlement APN changes, all mobile communications devices associated with that wireless communications network must be reprogrammed with the new entitlement APN. Furthermore, when a new service is introduced to the wireless communications network, then an associated entitlement APN must be programmed into those mobile communications devices.

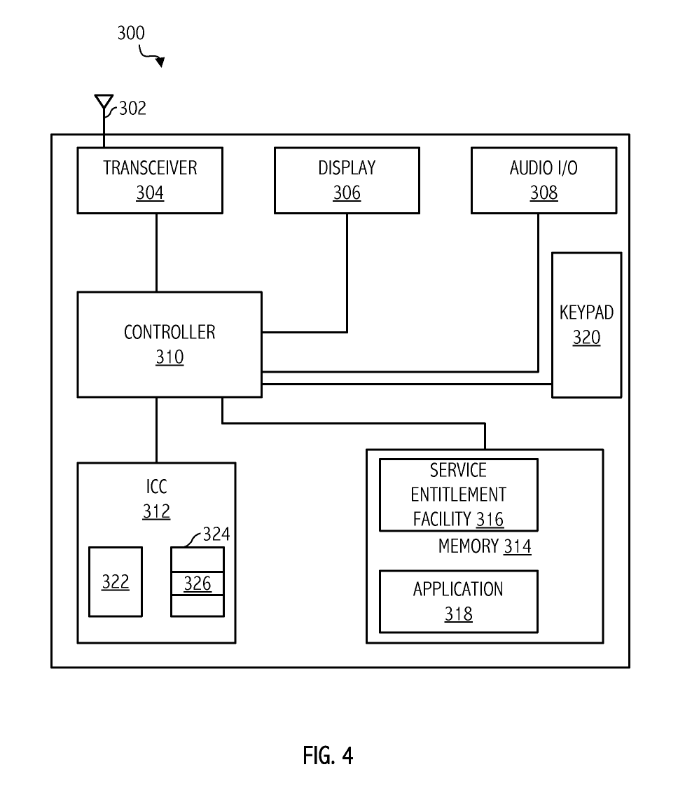

In at least one embodiment of a technique for provisioning a mobile communications device for a service reduces the amount of messaging and associated intra-network signaling from that illustrated in FIG. 2. Referring to FIG. 4, a technique for provisioning a mobile communications device for services to which the associated subscriber is entitled substantially reduces the network signaling of the technique of FIG. 2 by eliminating entitlement APNs and instead using a service entitlement profile stored in the mobile communications device to provision the mobile communications device for the service. Then, in at least one embodiment, the mobile communications device engages in the signaling of FIG. 3 when a user of the mobile communications device attempts to use a service outside the subscriber's rate plan.

In at least one embodiment, a mobile communications device (e.g., mobile communications device 300) includes transceiver 304 and user interfaces including, e.g., display 306, audio I/O 308, and keypad 320. In at least one embodiment, mobile communications device 300 includes an integrated circuit card (e.g., integrated circuit card 312), which is any smart card, chip card, or other card that includes embedded integrated circuits that process information. The integrated circuit card typically includes memory storage components (e.g., memory 324) and at least some logic circuits, which may include microprocessor circuits (e.g., processor 322). In at least one embodiment, integrated circuit card 312 includes other circuits not shown. Examples of an integrated circuit card include a Subscriber Identity Module (SIM) of a GSM device, a Universal Integrated Circuit Card (UICC) of a UMTS device, a Removable User Identity Module (RUIM) of a CDMA device, or other suitable, integrated circuit card.

In at least one embodiment, integrated circuit card 312 serves as an interface between mobile communications device 300 and wireless communications network 1000 that facilitates subscriber portability, e.g., replacement of the mobile communications device or change of carrier. The integrated circuit card typically includes a service-subscriber key used to identify a mobile communications device. The integrated circuit card allows a subscriber to change mobile communications devices by removing the integrated circuit card from one mobile communications device and inserting it into another mobile communications device. In at least one embodiment, using controller 310, integrated circuit card 312 can receive inputs and process those inputs using applications (e.g., application 318 stored in memory 314) to generate outputs.

In at least one embodiment of integrated circuit card 312, controller 310 processes information received from transceiver 304 and provides information to one or more of the user interfaces 306 and 308. In at least one embodiment, controller 310 receives information (e.g., user selection inputs, phone numbers dialed by the user, call content, data stream content, etc.) from one or more of the user interfaces and processes information for transmission. In at least one embodiment, controller 310 provides processed information to transceiver 304 for communications over a communications medium (e.g., over the air using antenna 302). Controller 310 may include one or more of a general purpose microprocessor and microcontroller circuits that execute software and/or firmware (e.g., application 318) stored in memory 314, co-processor circuits, custom circuitry, or other suitable circuitry.

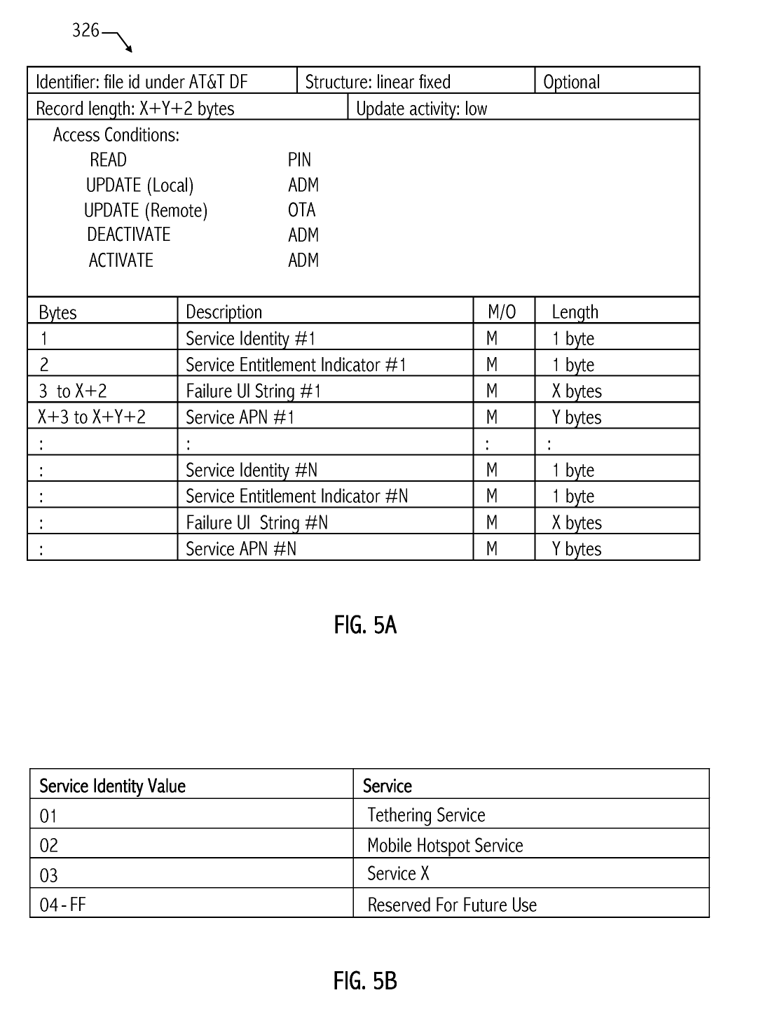

In at least one embodiment of integrated circuit card 312, memory 324 includes a subscriber entitlement profile (e.g., subscriber entitlement profile 326) that contains at least one record of entitlement policy information. In at least one embodiment, subscriber entitlement profile 326 has a linear fixed format; however, other embodiments include subscriber entitlement profiles with other suitable file formats. In at least one embodiment of subscriber entitlement profile 326, an entitlement record includes a service identifier and a service entitlement indicator. In at least one embodiment of subscriber entitlement profile 326, the entitlement record also includes a failure UI string, and/or a service APN. Referring to FIG. 5A, in at least one embodiment, subscriber entitlement profile 326 has a linear fixed format and includes service identity indicators, service entitlement indicators, failure UI strings, and/or a service APN for one or more service(s). In addition, subscriber entitlement profile 326 also includes access information. For example, a Personal Identification Number (PIN) is required to read to the file and an administrative code (ADM) is required to update the file. Referring to FIG. 5B, exemplary service identity values correspond to different services. An exemplary Failure UI string may be coded using any suitable data coding scheme, e.g., GSM default alphabet, language unspecified cell broadcast data coding scheme defined in 3GPP TS 23.038, 3rd Generation Partnership Project; Technical Specification Group Core Network and Terminals; Alphabets and language-specific information. The service APN may be coded using any suitable coding scheme, e.g., 3GPP TS 23.003, 3rd Generation Partnership Project; Technical Specification Group Core Network and Terminals; Numbering, addressing and identification. In at least one embodiment of mobile communications device 300, if the service APN field is empty (e.g., ‘FF . . . FF’), then mobile communications device 300 uses a default APN stored in memory 314 or memory 324.

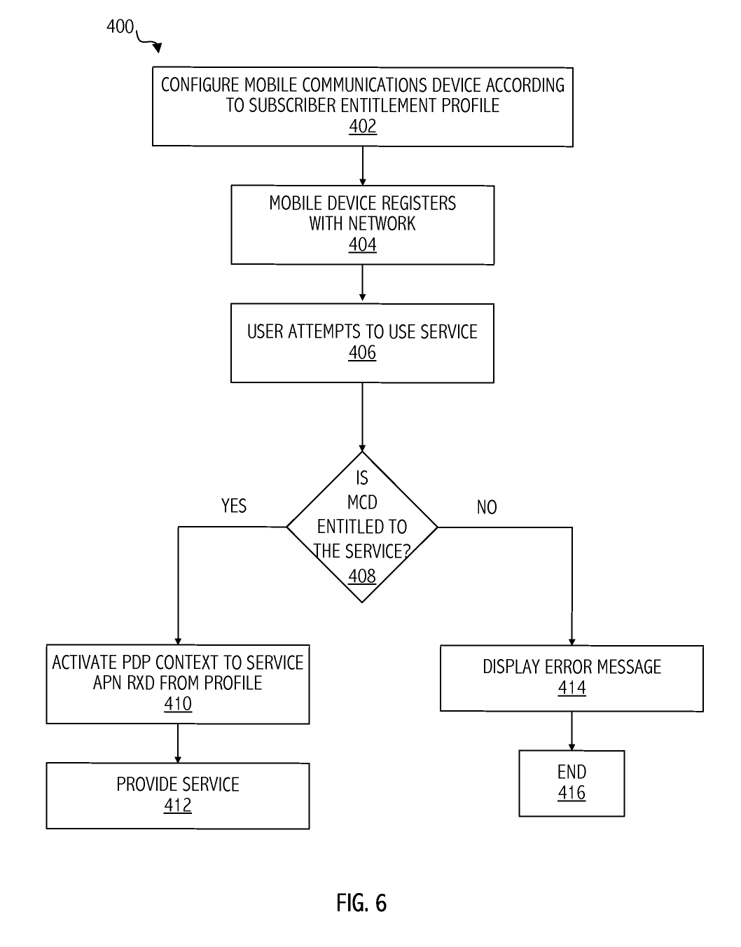

Referring to FIGS. 3, 4, and 6, in at least one embodiment of the technique for provisioning a mobile communications device for a service, upon power-up of mobile communications device 300, controller 310 configures mobile communications device 300 according to a subscriber entitlement profile 326 by accessing subscriber entitlement profile 326 on integrated circuit card 312 and setting flags in memory 314 or other suitable storage location, according to the subscriber entitlement profile (402). In at least one embodiment of the technique for provisioning a mobile communications device for a service, mobile communications device 300 registers with wireless communications network 1000 (404). In at least one embodiment of the technique, mobile communications device 300 registers with wireless communications network 1000 (404) upon powering up, and configuration 402 occurs after registration 404, or does not occur at all.

In at least one embodiment of the technique for provisioning a mobile communications device for a service, when a user of mobile communications device 300 attempts to use a particular service that is not part of the rate plan associated with mobile communications device 300 (406), mobile communications device 300 (e.g., service entitlement facility 316 executing on controller 310) accesses service entitlement profile 326 to retrieve an entitlement record associated with the particular service. In at least one embodiment, service entitlement facility 316 determines whether or not the subscriber associated with mobile communications device 300 is entitled to the service, e.g., based on the value of the service entitlement indicator (408). If the service entitlement indicator indicates that the subscriber is entitled to the service, then service entitlement facility 316 activates a PDP context for an access point indicated by a service APN, e.g., using signaling of FIG. 3 (410). In at least one embodiment of mobile communications device 300, the service APN is listed in the entitlement record. In at least one embodiment of the mobile communications device, the service APN is a default APN of mobile communications device 300. Once the PDP context is activated, the access point associated with the service APN (e.g., computer 1028 of FIG. 1) provides the service to mobile communications device 300. In at least one embodiment of mobile communications device 300, if the service entitlement indicator indicates that the subscriber is not entitled to the service (408), then service entitlement facility 316 provides an indication that the subscriber is not entitled to the service (414) and the technique ends (416).

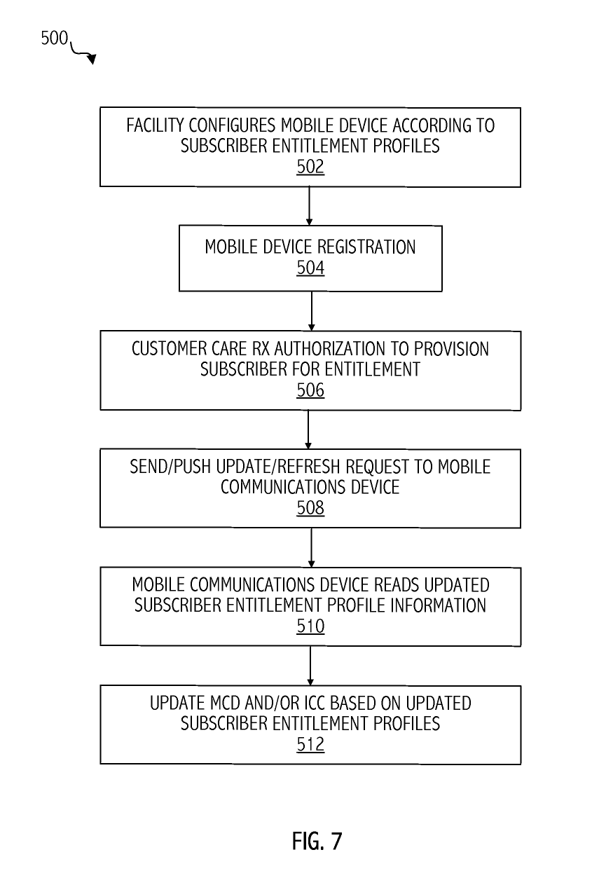

Referring to FIG. 7, in at least one embodiment of the service provisioning technique, service entitlement facility 316 configures the mobile communications device according to subscriber entitlement profile 326 upon power-up, reset, or other triggering event of mobile communications device 300 (502). In at least one embodiment of the service provisioning technique, mobile communications device 300 registers with a communications network (504). Note that in other embodiments of the service provisioning technique, mobile communications device 300 registers with a communications network prior to service entitlement facility 316 reading subscriber entitlement profile 326 and configuring the mobile communications device. A subscriber to the communications network may then contact customer care of the communications network from mobile communications device 300 or other communications device to provision a service. The subscriber may contact customer care to make the service selection using a voice call, text message, internet browser, e-mail or other suitable communications technique. Once customer care receives authorization information that entitles the subscriber to the service (e.g., subscriber identification, service identification, payment information, and/or other suitable information) (506), customer care adds billing information associated with that service to the subscriber's account via the communications network billing system and any required provisioning is performed on any required network elements (e.g., Home Location Register (HLR)).

In least one embodiment, customer care sends an over-the-air message to mobile communications device 300 that is used by mobile communications device 300 to set a corresponding service entitlement indicator (e.g., in service entitlement profile 326) of integrated circuit card 312 to indicate that the subscriber is entitled to that service. In addition, in at least one embodiment of the service provisioning technique, the service APN is provided to mobile communications device 300 at this time if there is a service APN associated with that particular service. In at least one embodiment of the service provisioning technique, customer care indicates to the mobile communications device that the subscriber entitlement information has changed and that the subscriber entitlement profile should be refreshed or updated (508). That indication may be communicated to the mobile communications device using any suitable technique. In at least one embodiment of the service provisioning technique, customer care pushes a refresh request to mobile communications device 300 via integrated circuit card 312 (508). Integrated circuit card 312 informs mobile communications device 300 that the contents of subscriber entitlement profile 326 have changed and that subscriber entitlement indicators on mobile communications device 300 should be updated based on the latest information in subscriber entitlement profile 326. Mobile communications device 300 reads the updated information from integrated circuit card 312 (510) and updates the service entitlement indicators on the mobile communications device 300 (512).

In at least one embodiment of the service provisioning technique, if the subscriber contacts customer care to cancel a service, or if a service expires (e.g., based on time, usage limits, or other condition), then the techniques described above are used to change the service entitlement indicator to indicate that the subscriber is no longer entitled to the service. In at least one embodiment of the service provisioning technique, the expiration of the time limit is monitored and detected by customer care. In at least one embodiment of the service provisioning technique, the expiration of the time limit is monitored and detected by service entitlement facility 316 or other application on mobile communications device 300. In at least one embodiment of the service provisioning technique, a service APN is reset using any of the techniques described above.

In at least one embodiment of the service provisioning technique, the service entitlement profile in the integrated circuit card has associated read/write permissions. In at least one embodiment of the service provisioning technique, read access of the service entitlement profile is granted upon providing a personal identification number, if one is enabled, and write access to the service entitlement profile is granted to a local or remote authorized user (e.g., service entitlement facility 316). Accordingly, in at least one embodiment of the service provisioning technique, only an authorized subscriber may use a particular service and only an authorized entity associated with the communications network can update the service entitlement profile.

Note that the service provisioning techniques described herein with respect to FIGS. 4-7 reduce or eliminate the need for periodic interrogation of entitlement APNs to detect cancellation of a service shortly after provisioning the service, reducing the likelihood of misuse or fraudulent activity as compared to the technique of FIG. 2. Since the techniques of FIGS. 4-7 include an entitlement check that is performed between mobile communications device 300 and integrated circuit card 312, in mobile communications devices that support only one Primary PDP, a service entitlement check does not require interruption of an executing application. Embodiments of the service provisioning technique described herein reduce the need to define any entitlement APNs on wireless communications network 1000, which reduces capital investment, shortens development time, and reduces the need to reprogram existing devices associated with the introduction of new services. The service provisioning technique described herein facilitates over-the-air updates of a mobile communications device to introduce new services, and service-specific failure strings can be set and/or updated on an integrated circuit card without intervention from device vendors. In addition, the service provisioning technique described herein facilitates definition and redefinition of service APNs in the network that are sent over the air to the mobile communications device for update of the information stored in the integrated circuit card without requiring reprogramming of the mobile communications device with the new APNs.

Structures described herein may be implemented using software executing on a processor (which includes firmware) or by a combination of software and hardware. Software, as described herein, may be encoded in at least one tangible computer readable medium. As referred to herein, a tangible computer-readable medium includes at least a disk, tape, or other magnetic, optical, or electronic storage medium.

While circuits and physical structures have been generally presumed in describing embodiments of the invention, it is well recognized that in modern semiconductor design and fabrication, physical structures and circuits may be embodied in computer-readable descriptive form suitable for use in subsequent design, simulation, test or fabrication stages. Structures and functionality presented as discrete components in the exemplary configurations may be implemented as a combined structure or component. Various embodiments of the invention are contemplated to include circuits, systems of circuits, related methods, and tangible computer-readable medium having encodings thereon (e.g., VHSIC Hardware Description Language (VHDL), Verilog, GDSII data, Electronic Design Interchange Format (EDIF), and/or Gerber file) of such circuits, systems, and methods, all as described herein, and as defined in the appended claims. In addition, the computer-readable media may store instructions as well as data that can be used to implement the invention. The instructions/data may be related to hardware, software, firmware or combinations thereof.

The description of the invention set forth herein is illustrative, and is not intended to limit the scope of the invention as set forth in the following claims. For example, while the invention has been described in an embodiment in which particular communications standards are used, one of skill in the art will appreciate that the teachings herein can be utilized with embodiments of the service provisioning technique of FIGS. 4-7 consistent with other communications standards. Variations and modifications of the embodiments disclosed herein, may be made based on the description set forth herein, without departing from the scope and spirit of the invention as set forth in the following claims.

What is claimed is:

1. A method for provisioning a mobile communications device for a service comprising:
transmitting a first indicator indicating a change to a service entitlement profile stored on the mobile communications device, the first indicator being transmitted by a wireless communications network to the mobile communications device.

2. The method, as recited in claim 1, further comprising:
transmitting a second indicator indicating entitlement to the service and an associated service access point name, the second indicator being transmitted by the wireless communications network to the mobile communications device.

3. The method, as recited in claim 2, wherein the service is not associated with a rate plan associated with the mobile communications device.

4. The method, as recited in claim 1, wherein the first indicator is transmitted in response to a communication between a subscriber associated with the mobile communications device and customer care associated with the wireless communications network.

5. The method, as recited in claim 4, wherein in the communication between the subscriber and customer care, the subscriber subscribes to the service.

6. The method, as recited in claim 1, wherein the first indicator is transmitted in response to expiration of the service for a subscriber associated with the mobile communications device.

7. An apparatus comprising:
a memory containing a subscriber entitlement profile for a subscriber to a wireless communications network; and
a controller configured to provide an indication of whether a subscriber associated with the integrated circuit card is entitled to a service based on the subscriber entitlement profile.

8. The apparatus, as recited in claim 7, wherein the memory and controller are included in an integrated circuit card.

9. The apparatus, as recited in claim 7, wherein the service is not associated with a rate plan associated with the subscriber.

10. The apparatus, as recited in claim 7, further comprising:
a service entitlement facility configured to access a service of the communications network based on a user request for the service and the indication.

11. The apparatus, as recited in claim 10, wherein the service entitlement facility is further configured to determine whether or not the subscriber is entitled to the service of the wireless communications network based on the subscriber entitlement profile stored in the memory and further configured to access the service if the subscriber is entitled to the service.

12. The apparatus, as recited in claim 10, wherein the service entitlement facility is further configured to update the subscriber entitlement profile in response to an over-the-air message including a refresh indicator indicating a change to the subscriber entitlement profile.

13. The apparatus, as recited in claim 10, wherein the service entitlement facility is further configured to activate a packet data protocol (PDP) context to a service access point corresponding to an access point name (APN) associated with the service and stored in the subscriber entitlement profile.

14. The apparatus, as recited in claim 7, wherein the service entitlement facility is further configured to display a failure message on the mobile communications device in response to a service entitlement indicator of the subscriber entitlement profile indicating that the subscriber is not entitled to the service.

15. The apparatus, as recited in claim 7, wherein the subscriber entitlement profile includes one or more of a service identity, a service entitlement indicator, and a failure indicator.

16. The apparatus, as recited in claim 7, wherein the subscriber entitlement profile includes a service access point name (APN).

17. The apparatus, as recited in claim 7, further comprising:
a mobile communications device including the memory and controller.

18. A method for provisioning a mobile communications device for a service comprising:
accessing a service access point of a wireless communications network in response to a request for the service and according to a subscriber entitlement profile stored in a mobile communications device.

19. The method, as recited in claim 18, wherein the subscriber entitlement profile is stored in an integrated circuit card of the mobile communications device.

20. The method, as recited in claim 18, wherein the service is not associated with a rate plan associated with the mobile communications device.

21. The method, as recited in claim 18, wherein the accessing comprises:
establishing a connection between the mobile communications device and the wireless communications network in response to the request for the service and a service entitlement indicator of the subscriber entitlement profile indicating that a subscriber associated with the mobile communications device is entitled to the service.

22. The method, as recited in claim 21, wherein the establishing the connection comprises:
activating a packet data protocol (PDP) context to the service access point corresponding to an access point name (APN) associated with the service and stored in the subscriber entitlement profile.

23. The method, as recited in claim 18, wherein the accessing comprises:
displaying a failure message on the mobile communications device in response to a service entitlement indicator of the subscriber entitlement profile indicating that a subscriber associated with the mobile communications device is not entitled to the service.

24. The method, as recited in claim 18, wherein the accessing comprises:
reading, from an entitlement record of the subscriber entitlement profile, a service entitlement indicator associated with the service.

25. The method, as recited in claim 18, further comprising:
updating the subscriber entitlement profile in response to an over-the-air message including a refresh indicator indicating a change to the subscriber entitlement profile.

26. The method, as recited in claim 25, further comprising:
updating a status of the mobile communications device based on a read of the subscriber entitlement profile after updating the subscriber entitlement profile.

27. The method, as recited in claim 25, further comprising:
generating the refresh indicator in response to expiration of the service for a subscriber associated with the mobile communications device.
